(19) United States
(12) Patent Application Publication
(10) Pub. No.: US 2024/0396267 A1
(43) Pub. Date: Nov. 28, 2024

(54) CONTACT ELEMENT FOR A PLUG CONNECTOR PART

(71) Applicant: Phoenix Contact GmbH & Co. KG, Blomberg (DE)

(72) Inventor: Arndt Schafmeister, Doerentrup (DE)

(21) Appl. No.: 18/685,519

(22) PCT Filed: Aug. 25, 2022
(86) PCT No.: PCT/EP2022/073651

§ 371 Date: Feb. 22, 2024

(30) Foreign Application Priority Data
Aug. 25, 2021 (LU) LU500571

(51) Int. Cl. H01R 13/6474; H01R 13/26; H01R 13/28; H01R 13/74

(52) U.S. Cl. CPC H01R 13/6474; H01R 13/26; H01R 13/28; H01R 13/745

(57) ABSTRACT

A contact element for a plug connector part for contacting a corresponding contact element of a mating plug connector part includes: a first end region for connecting to a printed circuit board; a second end region opposite from the first end region and having at least one contact lug; and a transition region located between the first end region and the second end region. At least some portions of the transition region have a geometry for impedance adjustment.

### CROSS-REFERENCE TO PRIOR APPLICATIONS

This application is a U.S. National Phase application under 35 U.S.C. § 371 of International Application No. PCT/EP2022/073651, filed on Aug. 25, 2022, and claims benefit to Luxembourg Patent Application No. LU 500571, filed on Aug. 25, 2021. The International Application was published in German on Mar. 2, 2023 as WO/2023/025876 under PCT Article 21 (2).

### FIELD

The invention relates to a contact element for a plug connector part, to a plug connector part having such a contact element, and to a plug connector system.

### BACKGROUND

Such contact elements for a plug connector part for contacting a corresponding contact element of a mating plug connector part comprise a first end region for connecting to a printed circuit board:
a second end region, the second end region being opposite from the first end region and having at least one contact lug, and
a transition region located between the first end region and the second end region.

Plug connector parts usually comprise a plurality of such contact elements, in each case for contacting a corresponding contact element of a mating plug connector part. For example, WO 2019/201768 A1 describes a plug connector part of this type having a hermaphroditic contact element.

When plugged together, the plug connector part and the mating plug connector part form a portion of a signal transmission path. In order to enable successful signal transmission, the impedance within the signal transmission path should be as constant as possible over the entire path. Especially for longer transmission paths, the plug connections can lead to an impedance mismatch.

Therefore, impedance adjustments are usually implemented through the design of the corresponding contact elements. For example, DE 11 2013 006 540 T5 proposes changing the geometry of a tip of a contact or barbs on the contact in order to improve the impedance.

U.S. Pat. No. 7,510,445 B2 proposes that a certain width ratio of specific locations on a contact lug can lead to an impedance improvement.

In the possibilities for impedance adjustment known from the prior art, different regions of the contact element which already fulfill a specific function, such as a region for connecting to a printed circuit board, or the plug face of the contact element, are geometrically modified. Such changes in regions which already fulfill a different function are complicated to realize and often also result in corresponding changes, for example changes in the plug faces or the corresponding contact elements of the mating plug connector part.

### SUMMARY

In an embodiment, the present invention provides a contact element for a plug connector part for contacting a corresponding contact element of a mating plug connector part, the contact element comprising: a first end region configured to connect to a printed circuit board: a second end region opposite from the first end region and having at least one contact lug; and a transition region located between the first end region and the second end region, wherein at least some portions of the transition region have a geometry for impedance adjustment.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a contact element according to one embodiment of the invention;

FIG. 2A, 2B are views of a plug connector part with contact elements according to FIG. 1:

FIG. 3 is a view of contact elements according to a further embodiment of the invention:

FIG. 4 is a view of a plug connector system with contact elements according to FIG. 1:

FIG. 5A-5D are views of contact elements according to embodiments of the invention with transition regions of different lengths; and

FIGS. 6A-6D are views of contact elements according to embodiments of the invention.

### DETAILED DESCRIPTION

In an embodiment, the present invention provides an improved contact element for a plug connector part, in particular a contact element which is constructed in a standardized manner and allows a simple impedance adjustment.

Accordingly, at least some portions of the transition region of the contact element comprise a geometry for impedance adjustment.

The transition region is located between the first end region and the second end region opposite from the first end region. For example, a soldering region, such as a connection tab or soldering lug, for connecting to a printed circuit board can be located on the first end region. For example, the connection tab can be connected to the printed circuit board and connected to an electrical conductor path on the printed circuit board.

The second end region has a contact lug which, for example, can be designed as a contact pin or as a bent end of the contact element. The contact lug can be brought into engagement with a corresponding contact lug of a corresponding contact element.

The transition region can extend flat along an extension direction and connect the first end region to the second end region. For example, the contact element can be manufactured as a punched metal part from a metal sheet. Without the applied geometry, the transition region of the contact element can have the shape of a strip, with a cross section which is constant at least in portions between the first end region and the second end region. The geometry for impedance adjustment can be applied to the cross section of the transition region, which cross section is constant in portions.

At least some portions of the transition region of the contact element comprise the geometry for impedance adjustment. The geometry can be molded onto the transition region, or can be applied as a cross-sectional reduction, such as, for example, as a recess or taper in the material of the transition region.

Advantageously, the impedance can be adjusted by the geometric design of the transition region. In order to keep the range of an impedance mismatch as small as possible, the transition region can be designed in a targeted manner. For example, the transition region can be designed to achieve a differential impedance of 100 ohms. Furthermore, such an optimization advantageously makes it possible to transmit over even larger printed circuit board distances, since in the case of larger printed circuit board distances, the transition region is usually highly significant in all considerations.

In comparison to the contact elements known from the prior art, standard elements can be located on the first end region and the second end region, for example as contact or soldering lugs, only the geometry of the transition region being changed for impedance adjustment.

In one embodiment, the geometry for impedance adjustment is designed as a cross-sectional enlargement of the transition region.

For example, along the running direction of the transition region, at least in one region, the cross section can be designed to be enlarged compared to the cross section in a remaining region of the transition region. For example, the cross-sectional enlargement can be designed in steps or continuously. In one example, the thickness and length of the transition region is constant, and the cross-sectional enlargement is achieved by increasing the width of the transition region.

In one embodiment, the geometry for impedance adjustment is designed as a cross-sectional reduction of the transition region.

For example, along the running direction of the transition region, at least in one region, the cross section can be designed to be reduced, i.e., tapered or lessened, compared to the cross section in a remaining region of the transition region. For example, the cross-sectional reduction can be carried out in steps or continuously. In one example, the thickness and length of the transition region is constant, the cross-sectional reduction being achieved by reducing the width of the transition region.

Since, above all, the second end region with the contact lug often constitutes an impedance sink, the transition region can advantageously serve for impedance compensation.

In one embodiment, a width-to-length ratio of the transition region is in a range from 1:1.5 to 1:2.5, in particular 1:2.

For example, the transition region can be substantially rectangular and have a constant width between the first end region and the second end region.

Surprisingly, it has been found that particularly good adjustment results can be achieved with a width-to-length ratio of the transition region of 1:2. Furthermore, it has been shown that the width-to-length ratio is easily scalable over a large range for different applications. An embodiment of the contact element with a width-to-length ratio of the transition region in a range from 1:1.5 to 1:2.5, in particular 1:2, can therefore advantageously create a contact element constructed in a standardized manner, which makes simple impedance adjustment possible.

In one embodiment, the geometry for impedance adjustment runs uniformly, at least in regions, in an extension direction of the transition region between the first end region and the second end region.

Here, the term “uniformly in an extension direction” can be understood to mean along the course of a line which is uniform at the points thereof. For example, the line can have a positive or negative slope. Alternatively, the slope of the line can also be 0.

Advantageously, the uniform course of the geometry allows an impedance adjustment to be performed easily and precisely.

In one embodiment, the geometry for impedance adjustment is located on at least one side portion of the transition region. For example, a web-shaped material portion can be located on the side portion in order to enlarge the cross section, or a corresponding web-shaped cutout can be located in the side portion in order to reduce the cross section, depending on the desired impedance adjustment.

For example, the web-shaped portion/cutout can be formed as a single piece together with the material of the contact element and/or have already been taken into account during the production of the contact element. Alternatively, the web-shaped portion/cutout can also have been added/removed after the contact element has been produced.

In one embodiment, the geometry for impedance adjustment is located on opposite side portions of the transition region.

Advantageously, by means of such an embodiment, mechanical loads of the contact element can be better counteracted, while an impedance adjustment can be carried out at the same time.

In one example, a width of the transition region having the geometry for impedance adjustment is in a range from 0.6 mm to 1 mm, in particular 0.8 mm.

For example, a plug connector with such contact elements can have a pitch of 0.8 mm. In one example, the impedance drops to about 85Ω for a width of 1 mm. Advantageously, the impedance adjustment can take place not only via a change in the cross section, but also via a change in the length of the transition region having the geometry for impedance adjustment. When the length is changed, a uniform course of the transition region can be achieved in order to avoid larger defects.

In one embodiment, the second end region has a further contact lug, the contact lug and the further contact lug extending together with the transition region in a first direction.

For example, the contact lugs can be designed so that the contact element can be plugged into a contact element which is mirror-inverted relative to a mirror plane. Advantageously, this can create a hermaphroditic contact element with a simple impedance adjustment for compensating the impedance sink caused by the contact lugs.

In one embodiment, the contact lug and the further contact lug are offset relative to one another along a second direction which extends transverse to the first direction, and also along a third direction which extends transverse to the first direction and transverse to the second direction.

Furthermore, the invention relates to a plug connector part having at least one contact element as described herein, in particular a plurality of contact elements as described herein.

For example, the plug connector part can comprise a housing made of a non-conductive material, for example a plastics material. The contact elements can be surrounded, at least in regions, by the material of the plug connector part, and can be held thereby.

In one example, the plug connector part has at least two contact elements, in particular a plurality of contact elements, an air gap being located between adjacent contact elements, and a width ratio of a width of the air gap to a width of the transition regions of the contact elements having the geometry for impedance adjustment being in a range from 1:0.9 to 1:1.1, in particular being 1:1.

For example, if a plurality of contact elements are used in a plug connector part, the distance of the contact elements relative to one another may be significant in the overall consideration for the impedance adjustment.

It has been shown that a fixed ratio of the width of the air gap to the width of the transition region over a large region can be easily scaled for different applications. Therefore, an embodiment of the width ratio in a range from 1:0.9 to 1:1.1, in particular by a width ratio of 1:1, can advantageously create a plug connector part constructed in a standardized manner, which makes simple impedance adjustment possible.

In one example, the plug connector part has at least two contact elements, in particular a plurality of contact elements, a plastics material being located between adjacent contact elements, and a width ratio of a width of the plastics material to a width of the transition regions of the contact elements having the geometry for the impedance adjustment being in a range from 0.5:0.9 to 0.5:1.1, in particular being 0.5:1.

For example, a liquid crystal polymer, LCP, can be arranged between the contact elements as a plastics material. LCPs advantageously have good dielectric properties. By using plastic materials, such as LCPs, the distance between adjacent contact elements can be reduced in order to accordingly realize a compact plug connector part.

The invention also relates to a plug connector system having a plug connector part as described herein and a mating plug connector part having at least one corresponding contact element, in particular a plurality of corresponding contact elements.

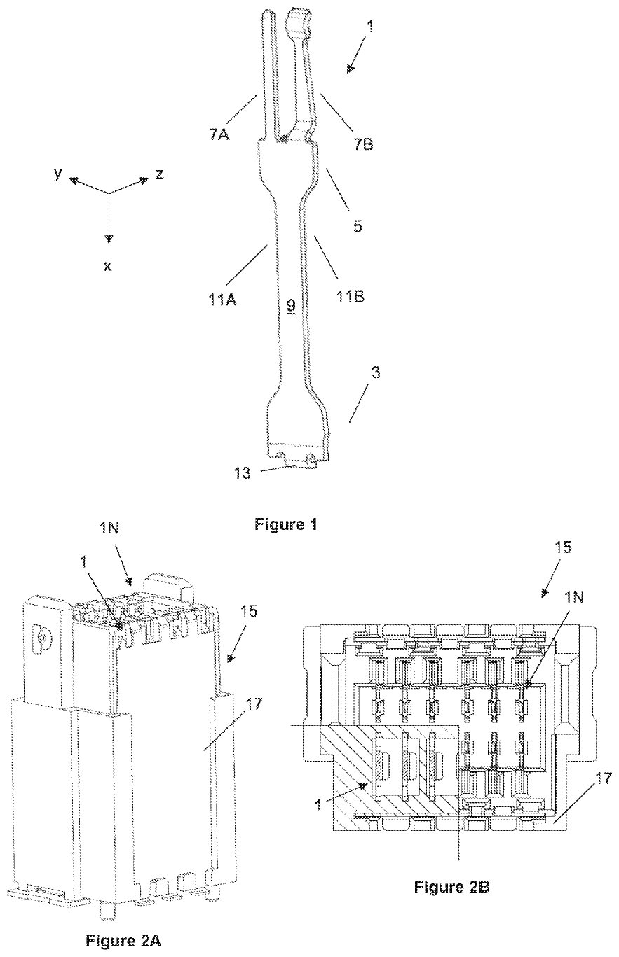

FIG. 1 shows a contact element 1 for a plug connector part for contacting a corresponding contact element of a mating plug connector part.

The contact element 1 shown has a first end region 3 for connecting to a printed circuit board. For this purpose, the first end region 3, as shown in FIG. 1, comprises a connection tab 13 which can be fastened to the printed circuit board for electrically connecting to a conductor path on the printed circuit board.

In the embodiment shown in FIG. 1, the second end region 5 opposite the first end region 3 has two contact lugs 7A, 7B.

The contact element 1 shown is a hermaphroditic contact element, so that two contact elements 1 designed in the same way on the second end region 5 can be inserted into one another in order to establish electrical contact between the contact elements, as is shown below in FIG. 4.

The contact lugs 7A and 7B extend together in a first direction X, the contact lug 7A and the further contact lug 7B being offset relative to one another along a second direction Y extending transverse to the first direction X, and also along a third direction Z extending transverse to the first direction X and transverse to the second direction Y.

Furthermore, it is shown in FIG. 1 that the transition region 9 is located between the first end region 3 and the second end region 5, and at least some portions of the transition region 9 have a geometry 11A, 11B for impedance adjustment, or the geometry has been applied to the transition region 9.

In FIG. 1, the geometry 11A, 11B for impedance adjustment is designed as a cross-sectional reduction of the transition region 9, and, as shown, is located on opposite side portions of the transition region 9. It is also shown that the geometry 11A, 11B for the impedance adjustment, at least in regions, runs uniformly in an extension direction of the transition region 9, along the first direction X, between the first end region 3 and the second end region 5.

FIG. 2A, 2B are views of a plug connector part 15 with contact elements 1, 1N according to the previously shown FIG. 1.

FIG. 2A is a perspective view of the plug connector part 15. As shown, a plurality of contact elements 1, 1N are located in a housing 17 of the plug connector part 15. The plug connector part 15 shown can be located on a printed circuit board and can be contacted with a corresponding mating plug connector part.

FIG. 2B is a plan view of the plug connector part 15 already shown in FIG. 2A. FIG. 2B shows a horizontal section through a region of the housing 17 (in the third quadrant) in order to better illustrate the arrangement of the contact elements 1, 1N in the housing.

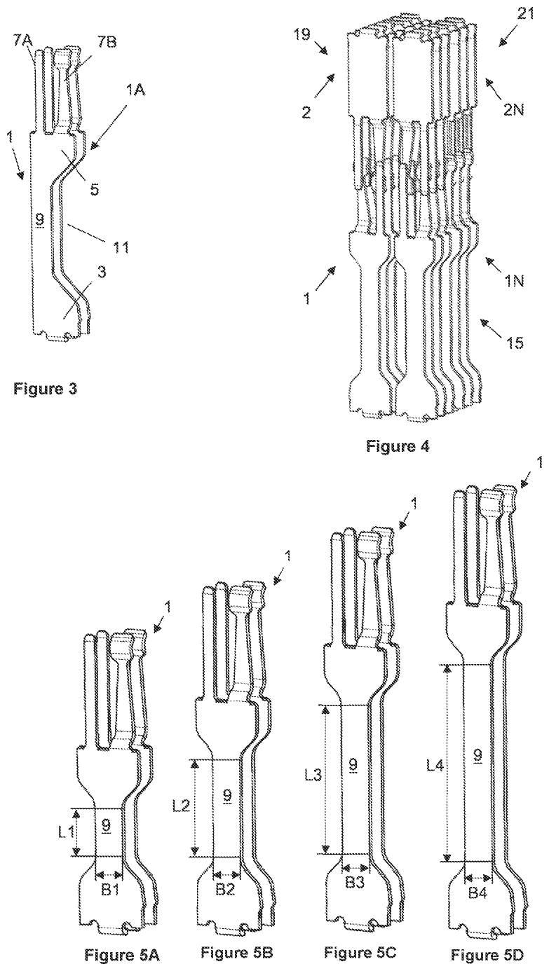

FIG. 3 shows views of two contact elements 1, 1A shown one after the other according to a further embodiment of the invention. In contrast to the embodiment shown in FIG. 1, the geometry for impedance adjustment 11 is located as a cross-sectional reduction only on one side region of the transition region 9.

FIG. 4 shows a plug connector system 21 with a plug connector part 15 as shown already in FIGS. 2A and 2B. For clarity, the plug connector part 15 is shown without the housing shown in FIGS. 2A and 2B.

Furthermore, FIG. 4 shows a mating plug connector part 19 (also without a housing) attached to the plug connector part 15 with corresponding contact elements 2, 2N. As shown in FIG. 4, the contact lugs of the corresponding contact elements 1, 1N are plugged together with the contact lugs of the corresponding contact elements 2, 2N and thus form a part of a signal transmission path. As shown, the transition regions of the corresponding contact elements 2, 2N do not have a geometry for impedance adjustment. In further embodiments, however, the transition regions of the corresponding contact elements 2, 2N can each have such a geometry.

FIGS. 5A-5D are views of contact elements 1 according to embodiments of the invention with transition regions 9 of different lengths.

FIG. 5A-5D show that a length-to-width ratio L/B of the transition regions 9 having the geometry for impedance adjustment is different in each case. In the embodiments shown, each of the lengths L1-L4 differ from one another, the widths B1-B4 remaining the same. Different values are thus obtained for the ratios L1/B1, L2/B2, L3/B3, and L4/B4.

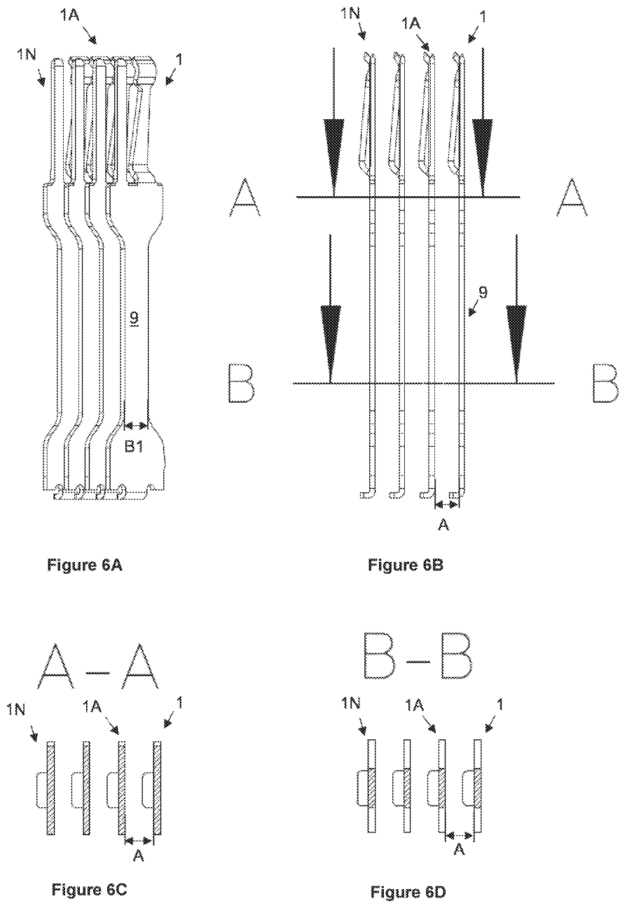

FIGS. 6A and 6B show a plurality of contact elements 1-1N arranged one behind the other, as located, for example, in the plug connector part shown in FIGS. 2A and 2B. For clarity, no housing is shown in FIGS. 6A and 6B.

In the embodiment shown in FIGS. 6A and 6B, an air gap is located between adjacent contact elements 1, 1A, and a width ratio of the width A of the air gap to a width B1 of the transition regions 9 of the contact elements 1, 1A is 1:1. In further embodiments, a plastics material can be located between adjacent contact elements 1, 1A as a dielectric. If there is a plastics material, a width ratio of a width of the plastics material to a width B1 of the transition regions can be 0.5:1.

FIGS. 6C and 6D are sectional views along the lines A-A and B-B shown in FIG. 6B.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference signs

| | |
|---|---|
| 1-1N | Contact element |
| 2-2N | Corresponding contact |
| 3 | First end region |
| 5 | Second end region |
| 7A, 7B | Contact lug |
| 9 | Transition region |
| 11, 11A, 11B | Geometry for impedance |
| 13 | Connection tab |
| 15 | Plug connector part |
| 17 | Housing |
| 19 | Mating plug connector |
| 21 | Plug connector system |
| L, L1-L4 | Length |
| A, B, B1-B4 | Width |
| A-A, B-B | Section |
| X | First direction |
| Y | Second direction |
| Z | Third direction |

1. A contact element for a plug connector part for contacting a corresponding contact element of a mating plug connector part, the contact element comprising:
a first end region configured to connect to a printed circuit board;
a second end region opposite from the first end region and having at least one contact lug; and
a transition region located between the first end region and the second end region,
wherein
at least some portions of the transition region have a geometry for impedance adjustment.

2. The contact element of claim 1, wherein the geometry for impedance adjustment comprises a cross-sectional enlargement of the transition region.

3. The contact element of claim 1, wherein the geometry for impedance adjustment comprises a cross-sectional reduction of the transition region.

4. The contact element of claim 3, wherein a width-to-length ratio (B/L) of the transition region is in a range from 1:1.5 to 1:2.5.

5. The contact element of claim 1, wherein the geometry for impedance adjustment runs uniformly at least in regions in an extension direction of the transition region between the first end region and the second end region.

6. The contact element of claim 1, wherein the geometry for impedance adjustment is located on at least one side portion of the transition region.

7. The contact element of claim 1, wherein the geometry for impedance adjustment is located on opposite side portions of the transition region.

8. The contact element of claim 1, wherein a width of the transition region having the geometry for impedance adjustment is in a range from 0.6 mm to 1 mm.

9. The contact element of claim 1, wherein the second end region has a further contact lug, the contact lug and the further contact lug extending together with the transition region in a first direction.

10. The contact element of claim 9, wherein the contact lug and the further contact lug are offset relative to one another along a second direction extending transverse to the first direction, and also along a third direction extending transverse to the first direction and transverse to the second direction.

11. A plug connector part, comprising:
at least one contact element claim 1.

12. The plug connector part of claim 11, wherein the at least one contact element comprises at least two contact elements, an air gap being located between adjacent contact elements of the at least two contact elements, and
wherein a width ratio (A/B) of a width of the air gap to a width of the transition regions of the contact elements having the geometry for impedance adjustment is in a range from 1:0.9 to 1:1.1.

13. The plug connector part of claim 11, wherein the at least one contact element comprises at least two contact elements, a plastics material being located between adjacent contact elements of the at least two contact elements, and
wherein a width ratio (A/B) of a width of the plastics material to a width of the transition regions of the contact elements, having the geometry for impedance adjustment being in a range from 0.5:0.9 to 0.5:1.1.

14. A plug connector system, comprising:
the plug connector part of claim 11; and
a mating plug connector part having at least one corresponding contact element.

15. The contact element of claim 4, wherein the width-to-length ratio (B/L) of the transition region is 1:2.

16. The contact element of claim 8, wherein the width of the transition region having the geometry for impedance adjustment 0.8 mm.

17. The plug connector part of claim 11, wherein the at least one contact element comprises a plurality of contact elements.

18. The plug connector part of claim 12, wherein the at least two contact elements comprises a plurality of contact elements, and
wherein the width ratio (A/B) is 1:1.

18. The plug connector part of claim 13, wherein the at least two contact elements comprises a plurality of contact elements, and
wherein the width ratio (A/B) is 0.5:1.

19. The plug connector system of claim 14, wherein the at least one corresponding contact element comprises a plurality of corresponding contact elements.
